(19) United States
(12) Patent Application Publication
(10) Pub. No.: US 2012/0185612 A1
(43) Pub. Date: Jul. 19, 2012

(54) APPARATUS AND METHOD OF DELTA COMPRESSION

(75) Inventors: Yuhong Zhang, San Jose, CA (US); Jiebing Wang, San Jose, CA (US)

(73) Assignee: EXAR CORPORATION, Fremont, CA (US)

(21) Appl. No.: 13/009,175

(22) Filed: Jan. 19, 2011

(51) Int. Cl. G06F 15/16

(52) U.S. Cl. 709/247

(57) ABSTRACT

A method includes aligning a reference window and target window for compression of a target data stream in terms of a reference data stream. The anchors are determined by examining the target data stream and reference data streams. The target data stream is aligned with respect to the reference data streams using the anchors. Pattern matching between the aligned target data stream and reference data stream is done to delta compress the target data stream.

### BACKGROUND

Most compression techniques are concerned with processing a single data stream. Delta compression on the other hand is the compression of one data stream, referred to as the target data stream, in terms of another data stream, called the reference data stream, by computing a delta. The delta can be viewed as an encoding of the difference between the target and the reference data stream. The target data stream can be later recovered from the delta and the reference data stream. Delta compression can be based on byte-to-byte comparisons. Delta compression is different from hash-based deduplication methods. Delta compression can provide for a finer comparison result than hash-based deduplication methods.

Delta compression is used in revision control systems. By storing deltas of different versions instead of the actual data, these systems are able to reduce storage requirements significantly. For example, Xdelta File System (XDFS) developed by Joshua MacDonald is a file system implemented with delta compression. Another application of delta compression is software distribution; especially the software that is distributed over the Internet. By distributing deltas, or essentially patches, one can significantly reduce network traffic. Delta compression can also be used to improve HTTP performance. By exploiting the similarity between different pages on a given website or between the different versions of a given web page, one can reduce the latency for web access. VCDIFF is defined in RFC 3284 to support this kind of usage.

But in many cases, due to deleting or inserting operations, the reference data is no longer aligned with target data. If reference data and target data are misaligned too much, the incoming target data can't find matched pattern in reference data window. The compression ratio will then be dramatically degraded. There are already several delta compressors available including xdetla, vdelta (and its newer variant VCDIFF) and zdelta. None of them avoids the problem.

### SUMMARY OF THE INVENTION

Delta compression logic pattern matches using a reference window and a target window. The reference and target data is aligned during delta compression so that the reference and target windows contain similar data. In this way, a better compression ratio can be achieved.

An intelligent alignment can be implemented by indentifying one or more anchor pairs by examining the target and reference data streams. The anchor pairs can be determined by using Rabin-Karp or a similar rolling hash algorithm. Each byte in the target or reference data stream has a rolling hash result that corresponds to a hash of a multiple byte window,

A reference anchor candidate is located when a feature pattern is found in the rolling hash results of reference data stream. The rolling hash result is also referred to as fingerprint value of the reference anchor candidate. If an anchor candidate from the target data has the same fingerprint value as a counterpart from the reference data, an anchor pair is identified.

With such anchor pair, the invention can use much smaller reference window than other tools. This can simplify the computation complexity and improve performance. The use of a smaller reference window also makes hardware implementation feasible by saving memory resources on a chip.

### BRIEF DESCRIPTION OF THE DRAWINGS

FIG. 1 shows an example of inserting some text into target data.

FIG. 2 is an example of prior art delta compression solution.

FIG. 3 is a diagram of an embodiment of the present invention which uses anchors to align the delta compression.

FIG. 4 illustrates a procedure to find an anchor candidate.

FIG. 5 shows a flow chart of one embodiment of the invention.

FIG. 6 shows an exemplary delta compressor.

FIG. 7 shows an exemplary delta decompressor.

FIG. 8 shows an exemplary anchor pair determination.

### DESCRIPTION

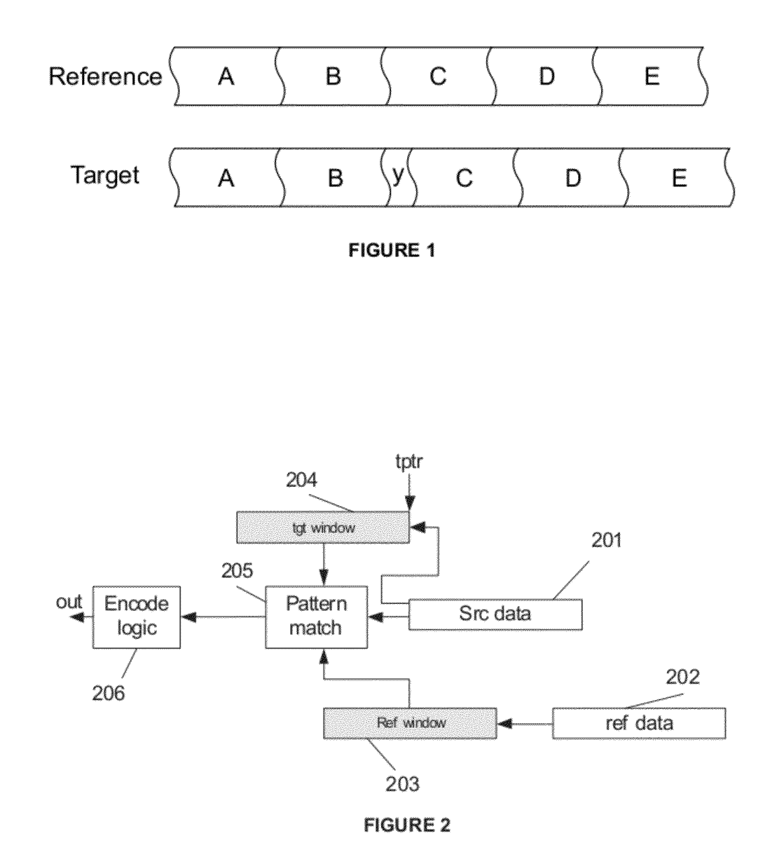

Adding or deleting data from an old file version to a new file version can happen daily. The advantage of delta compression is that only the difference need be stored. FIG. 1 shows an example. A data segment y is inserted in the target data stream.

The segment y can be identified and encoded in delta compression. Delta compression saves storage space by referring to data in the reference stream.

All delta compressors compare the incoming target data stream with a reference data stream. Some compressors also compare the incoming target data with the previous target data (target history).

FIG. 2 is an example of a prior art system. Source data (also called as target data) 201 is compared to reference data using a reference window 203 and target window 204 to find pattern matching. The best compression ratio is achieved when reference window is big enough to hold the whole reference data stream. But for cost effectiveness reasons, typically not the all of the reference data is compared with the incoming target data. Instead, as in most compression systems, only a part of reference data is stored in reference window and participates in comparison. So if the data pattern in reference data stream happens to be not in reference window, no pattern will be found. The compression ratio will degrade dramatically if target data can't find matched pattern in reference window. For example, if the data segment y in FIG. 1 is bigger than the size of reference window, the target data segment after data y will not find matched pattern in reference window.

A delta compression method can comprise determining anchors to align a reference window and target window for compression of a target data stream in terms of a reference data stream. The anchors can be determined by examining the target data stream and reference data stream. The target data stream can then be aligned with respect to the reference data stream. Pattern matching between the aligned target data stream and reference data stream can be used to delta compress the target data stream.

A delta decompression method can comprise using anchors to align a reference window and target window for decompressing of a target data stream in terms of a reference data stream using a delta. The anchors can be previously determined by examining the target data stream and reference data stream during compression of the target data stream. The target data stream can be decompressed using the aligned reference and target windows.

A delta compressor 600 can include a reference window 602, a target window 604, and an anchor determining block 606 to determine anchors by examining the target data stream and reference data stream. As discussed below, the anchor determining block 606 can use a rolling hash algorithm. An aligning block 608 can align the target data stream with respect to the reference data stream in the reference and target windows using the anchors. A pattern matching block 610 can pattern match between the aligned target data stream and reference data stream to delta compress the target data stream using encoder 612.

The compressed delta 616 can be stored on a computer readable medium 614. The delta 616 can be later used to decompress the target data stream along with the reference data stream. The delta 616 can include anchor pairs 618 from the anchor determining block 606 indicating where to align the reference and target data streams. Delta information 620 from the encoder 612 can indicate how to decompress the aligned target data stream with respect to the reference data stream. Thus, the delta 616 can be decompressed to produce the target data stream using the computer readable medium.

A delta decompressor 700 can use a computer readable medium 614 to provide the delta information 620 and anchor pairs 610. The anchor pairs 610 are provided to an alignment block 702 that aligns the reference window 704 and target window 706. The decompressor block 708 receives the delta information 620 and the aligned reference data and produces the target data stream that is sent to the target window 706.

The anchors can be selected by using a hash method, such as a rolling hash method. The hash method can be implemented in hardware.

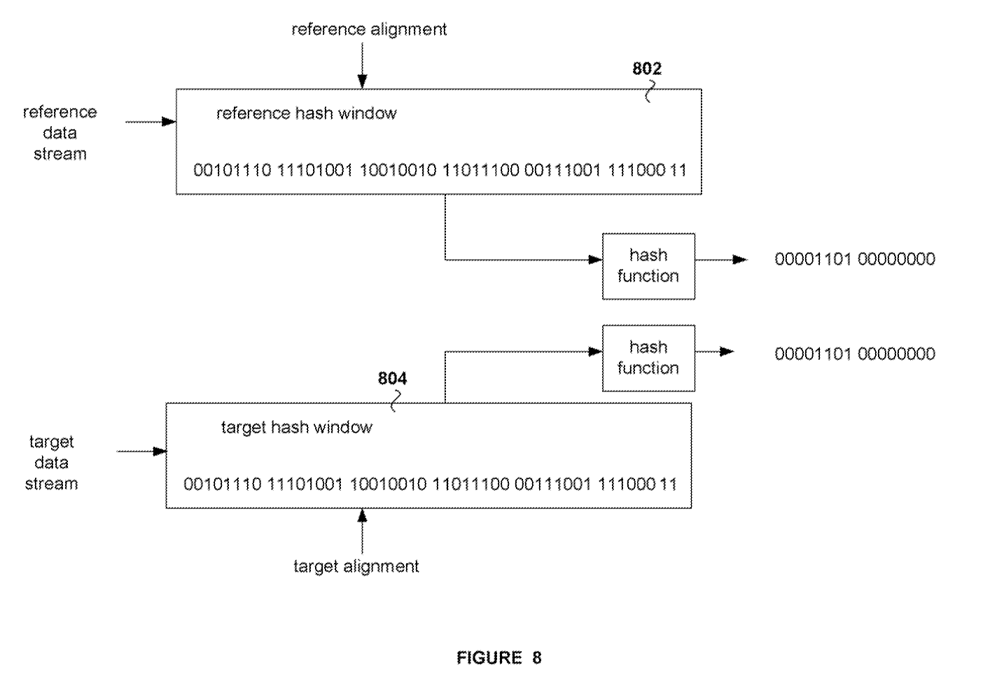

FIG. 8 shows an exemplary anchor pair determination. The reference data stream and target data stream can be streamed into a reference hash window 802 and target hash window 804 respectively. The size of the reference and target hash windows can be different from the size of the reference and target windows. The reference hash window 802 and target hash window 804 can correspond to different offset positions in the reference and target data stream respectively. The hash outputs of the reference and target hash windows will typically often match since the target and reference streams will typically be similar when aligned. In the example of FIG. 8, both reference and target hash values are “00001101 00000000”. An anchor pair can be determined when at least a portion of the reference and target hash values matches a predetermined pattern, such as when the last portion of the hash values match the value “00000000” as in FIG. 8. The anchor pair can correspond to the offsets when there is a match with the predetermined pattern.

The reference data stream and target data stream can be streamed into the reference window and target window respectively until an anchor value is reached. At that time, one of the reference or target data streams is stalled until the reference and target data streams are aligned.

Anchors label the same parts of content between reference and target data stream. Anchors can be represented as the pair (offset of reference anchor, offset of target anchor).

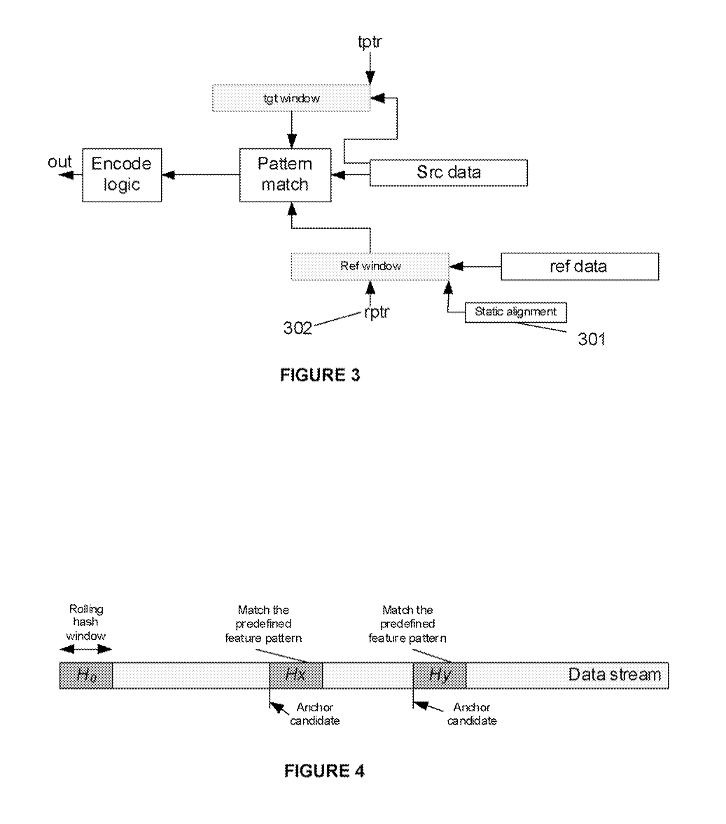

FIG. 3 shows an embodiment of the present invention. Anchors can be read in by the compressor before pattern match. During pattern match, the compressor can adjust reference window pointers according to the anchors 302. The compressor pulls in reference data at a faster pace if the reference offset is bigger than target offset, which would be the result of text being deleted in the target data stream with respect to the reference data. The compressor stalls the reference window if reference offset is smaller than target offset, which would be the result of text being inserted in the target data stream with respect to the reference data stream.

Anchors can be determined by rolling hash algorithms. A rolling hash is a hash function where the input is hashed in a sliding window that moves through the input. A few hash functions allow a rolling hash to be computed very quickly—the new hash value is rapidly calculated given only the old hash value, the old value removed from the hash window, and the new value added to the hash window—similar to the way a moving average function can be computed much more quickly than other low-pass filters. Hash functions can also be efficiently implemented in hardware. FIG. 4 shows an exemplary rolling hash.

Let us take Rabin-Karp algorithm as example. The Rabin-Karp algorithm is normally used with a very simple rolling hash function that only uses multiplications and additions:

Hₖ=(c₁α^{k-1}+c₂α^{k-2}+c₃^{k-3}+ . . . +cₖα⁰) mod M, where a M is a constant and c1, . . . , ck are the input characters.

In order to avoid manipulating huge H values, all math is done modulo M.

Removing and adding characters simply involves adding or subtracting the first or last term. Shifting all characters by one position to the left requires multiplying the entire sum Hₖ by α. The calculation of Hₖ₊₁ can be simplified as:

Hₖ₊₁=((Hₖ−c₁α^{k-1})*α+cₖ₊₁) mod M

So sweeping through the whole reference data stream, each rolling hash sliding window can generate a hash result. If the hash result is matched with the predefined feature pattern (e.g. a selected number of least significant bit “0”s), the hash result and reference offset are recorded as reference anchor candidate. The hash result is also referred as the fingerprint of the anchor candidate. An anchor candidate can be represented as the pair (anchor offset, anchor fingerprint).

The target anchor candidates can be determined in the same way. If the fingerprint of the target anchor candidate is same as a reference anchor candidate, an anchor pair is identified.

The hash result can be updated at the byte level such that a hash value is determined for each byte of the target and reference data stream. For example, for the following data stream: Byte0, Byte1, . . . , ByteN-1, ByteN, ByteN+1 . . . , if we define the window size to N, the first rolling hash result can be calculated on [Byte0, Byte1, . . . , ByteN-1], the second rolling hash result can be calculated on [Byte1, Byte2, . . . ByteN] and the third result can be calculated on [Byte2, Byte3, . . . , ByteN+1]. In this way, each byte can correspond to a rolling hash result. Since the rolling hash drops the oldest byte each time, the complexity of the computation is linear.

Anchor density can be adjusted. For example, we can configure to identify an anchor pair every 2 KB in average by configuring the feature pattern with the least significant 11 bit “0”s. For density of 1 KB, by configuring the feature pattern with the 10 least significant “0”s. Higher density will result in better delta compression ratio, but more processing in the anchor determination.

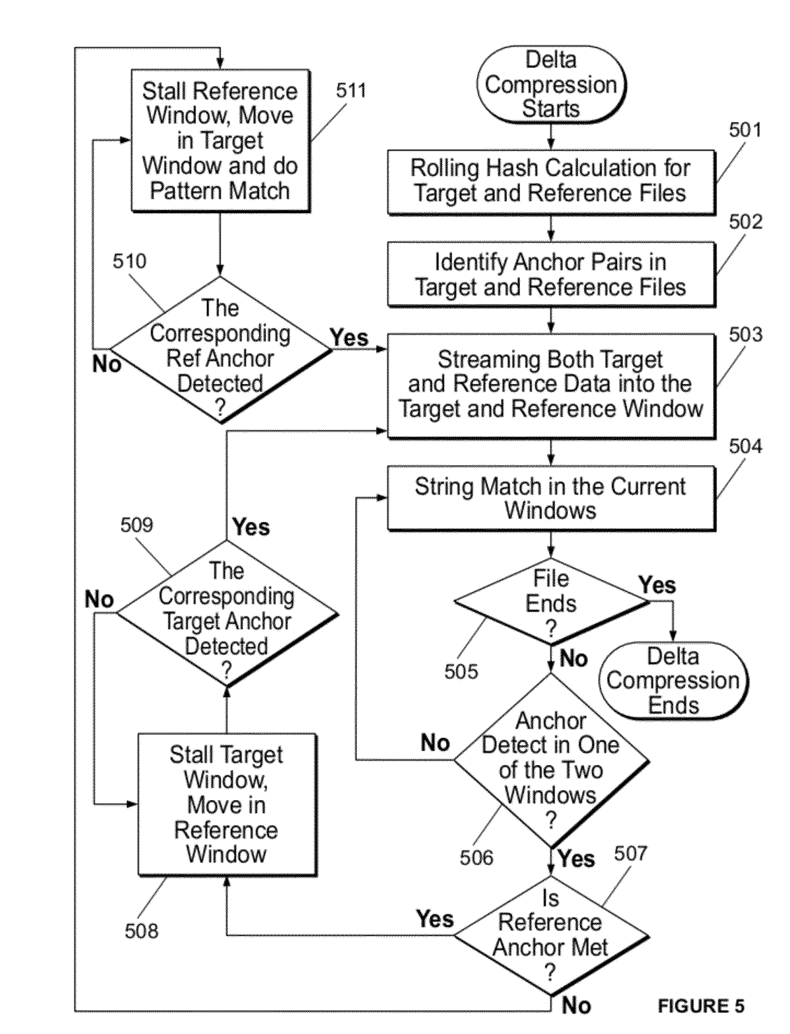

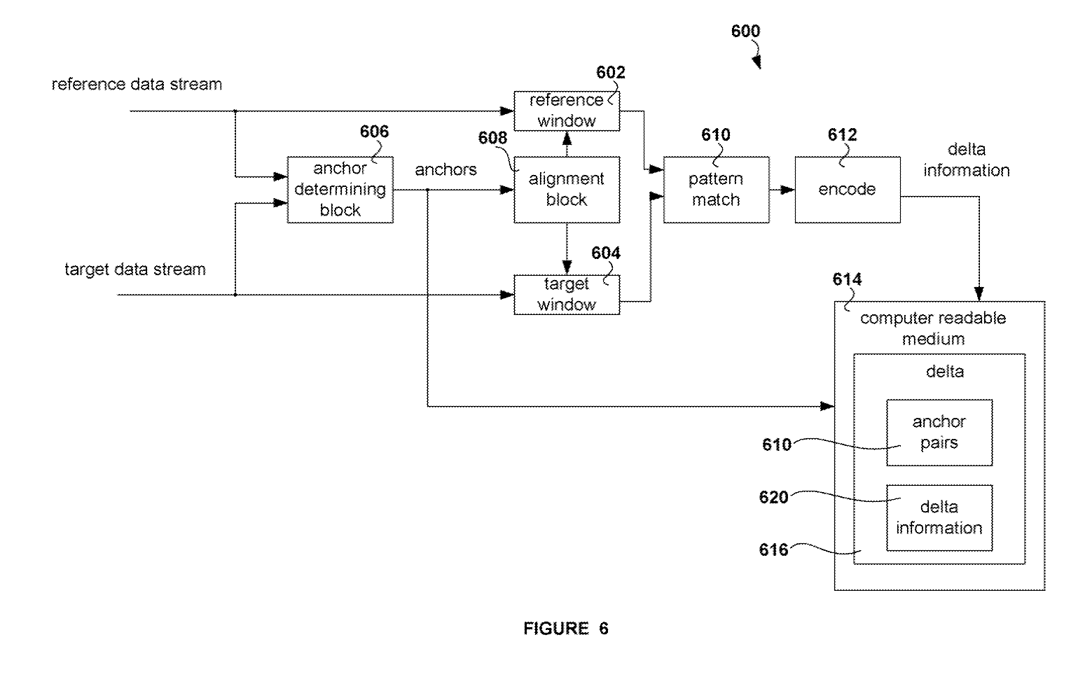

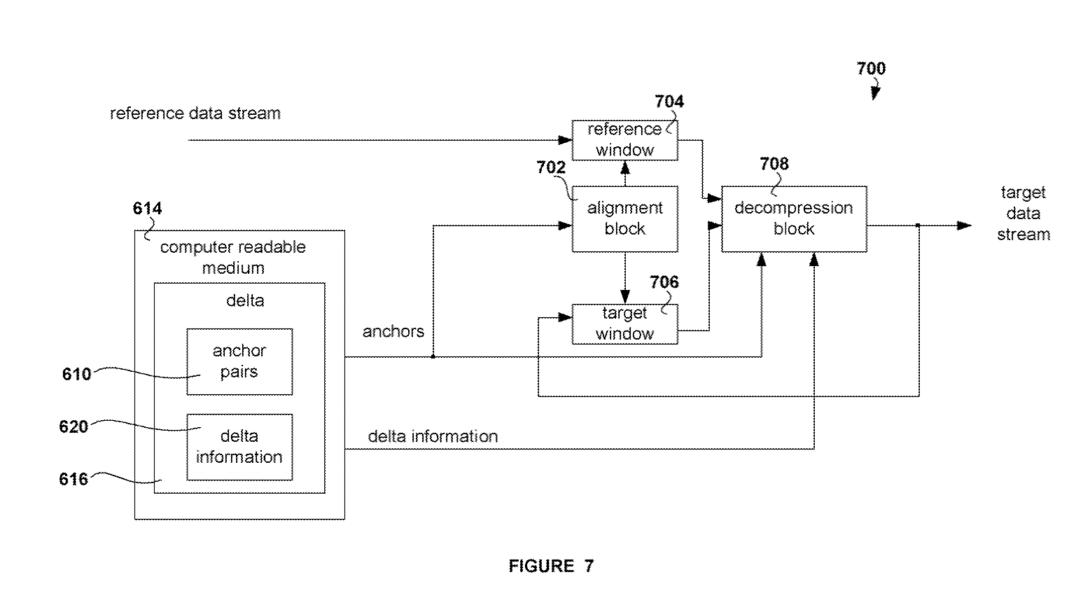

The workflow of one embodiment is shown in FIG. 5. A rolling hash algorithm is calculated on target and reference data stream in step 501. Anchor candidates are recorded if they match predefined feature pattern so that anchor pairs can be identified later on in step 502.

Target data and reference data are streamed in for pattern match in step 503. During the pattern match processing in step 504, if an anchor pair is detected, the compressor has to align the reference window and target window. The anchor pair can be represented as the pair (offset of reference anchor, offset of target anchor). The compressor can maintain a reference offset counter and a target offset counter. The reference offset counter can be incremented when a new character is moved into the reference window. The target offset counter can be incremented when a new character is moved into the target window. An anchor is detected when either offset counter hits an anchor in step 506.

In the alignment process, if reference data stream is ahead of the target data stream, i.e., the compressor meets reference anchor before the corresponding target anchor 507, the compressor can stall the reference window, while target data is streamed in and do pattern match in step 508, until the target offset of the same anchor is met in step 509.

If target data stream is ahead of reference data stream, i.e., the compressor meets target offset of an anchor first in step 510, the compressor can stall the target window and stream reference data in the reference window in step 511 until the reference offset of the same anchor is met in step 512. No pattern match is performed.

The post pattern match result is encoded and output.

During decompression, the same anchor pairs are input to decompressor before decompression. When anchors are detected by decompressor during the processing, decompressor is able to align the reference window and target window to recover data back.

Experiments show that the invention can use much smaller reference window than other tools. This could simplify the computation complexity and improve performance. Smaller reference window also makes hardware implementation feasible by saving a lot of memory resources on chip.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

1. A delta compression method comprising:
determining anchors to align a reference window and target window for compression of a target data stream in terms of a reference data stream, the anchors being determined by examining the target data stream and reference data stream;
aligning the target data stream with respect to the reference data stream; and
pattern matching between the aligned target data stream and reference data stream to delta compress the target data stream.

2. The delta compression method of claim 1, wherein the anchors are selected by using a hash method.

3. The delta compression method of claim 2, wherein the hash method is implemented in hardware.

4. The delta compression method of claim 2, wherein the anchors are selected in a rolling hash method.

5. The delta compression method of claim 4, wherein the anchors are selected when at least a portion of the rolling hash values in hash windows of both the reference and target delta stream match a predetermined value.

6. The delta compression method of claim 5, wherein the reference data stream and target data stream are streamed into the reference window and target window respectively until an anchor value is reached, at that time one of the reference or target data streams are stalled until the reference and target data streams are aligned.

7. The delta compression method of claim 1, wherein the anchors are stored as the pair (offset of reference anchor, offset of target anchor).

8. A delta decompression method comprising:
using anchors to align a reference window and target window for decompression of a target data stream in terms of a reference data stream using a delta, the anchors being previously determined by examining the target data stream and the reference data stream during compression of the target data stream;
decompressing the target data stream using the aligned reference and target windows.

9. The delta decompression method of claim 8, wherein the anchors are selected in a rolling hash method.

10. The delta decompression method of claim 9, wherein the anchors are selected when at least a portion of the rolling hash values in hash windows of both the reference and target delta streams match a predetermined value.

11. The delta decompression method of claim 8, wherein the anchors are stored as the pair (offset of reference anchor, offset of target anchor).

12. A delta compressor comprising:
a reference window;
a target window;
an anchor determining block to determine anchors by examining the target data stream and reference data stream;
an aligning block to align the target data stream with respect to the reference data stream in the target and reference windows; and
a pattern matching block to pattern matching between the aligned target data stream and reference data stream to delta compress the target data stream.

13. The delta compressor of claim 12, wherein the anchors are selected by using a hash method.

14. The delta compressor of claim 13, wherein the hash method is implemented in hardware.

15. The delta compressor of claim 13, wherein the anchors are selected in a rolling hash method.

16. The delta compressor of claim 14, wherein the anchors are selected when at least a portion of the rolling hash values in hash windows of both the reference and target delta streams match a predetermined value.

17. The delta compressor of claim 12, wherein the reference data stream and target data stream are streamed into the reference window and target window respectively until an anchor value is reached, at that time one of the reference or target data streams are stalled until the reference and target data streams are aligned.

18. The delta compressor of claim 12, wherein the anchors are stored as the pair (offset of reference anchor, offset of target anchor).

19. A computer readable medium containing a delta for decompressing a target data stream;
the delta including:
anchor pairs indicating where to align a reference and target data stream; and
delta information indicating how to decompress the aligned target data stream with respect to the reference data stream.

20. The computer readable medium of claim 19, wherein the anchors are stored as the pair (offset of reference anchor, offset of target anchor).
